(19) United States
(12) Patent Application Publication
(10) Pub. No.: US 2020/0212504 A1
(43) Pub. Date: Jul. 2, 2020

(54) COMPACT ABSORBENT GLASS MAT BATTERY

(71) Applicant: CLARIOS GERMANY GMBH & CO. KGAA, Hannover (DE)

(72) Inventors: Roderique DUELL, Hannover (DE); Ruediger JAEPPELT, Hildesheim (DE); Christian Stefan MENZEL, Sarstedt (DE); Nadine DEHNERT, Seelze (DE); Dirk GOEBBELS, Hannover (DE)

(73) Assignee: Clarios Germany GmbH & Co. KGaA, Hannover (DE)

(21) Appl. No.: 16/619,873

(22) PCT Filed: Jun. 8, 2018
(86) PCT No.: PCT/IB2018/000721

§ 371 Date: Dec. 5, 2019

Related U.S. Application Data
(60) Provisional application No. 62/641,092, filed on Mar. 9, 2018.
(60) Provisional application No. 62/589,889, filed on Nov. 22, 2017.
(60) Provisional application No. 62/584,577, filed on Nov. 10, 2017.
(60) Provisional application No. 62/530,714, filed on Jul. 10, 2017.
(60) Provisional application No. 62/517,749, filed on Jun. 9, 2017.

(51) Int. Cl. H01M 10/12; H01M 2/16; H01M 4/73

(52) U.S. Cl. CPC H01M 10/128; H01M 4/73; H01M 2/1613; H01M 10/121

(57) ABSTRACT

A compact AGM lead acid battery is disclosed. The battery has a container and one or more electrically connected cells in the container. The electrically connected cells are formed by a plurality of positive plates and plurality of negative plates, wherein an absorbent glass mat is interleaved between positive and negative plates. Electrolyte is provided within the container. The lead acid battery has an improved battery performance per volume and less lead weight than a conventional AGM lead acid battery or EFB lead acid battery.

### CROSS-REFERENCE TO RELATED APPLICATIONS

This application claims priority to U.S. Provisional Patent Application, Ser. No. 62/517,749, filed Jun. 9, 2017, entitled COMPACT ABSORBENT GLASS MAT BATTERY; U.S. Provisional Patent Application, Ser. No. 62/530,714, filed Jul. 10, 2017, entitled COMPACT ABSORBENT GLASS MAT BATTERY, U.S. Provisional Patent Application, Ser. No. 62/584,577, filed Nov. 10, 2017, entitled COMPACT ABSORBENT GLASS MAT BATTERY; and U.S. Provisional Patent Application, Ser. No. 62/589,889, filed Nov. 22, 2017, entitled COMPACT ABSORBENT GLASS MAT BATTERY; and U.S. Provisional Patent Application, Ser. No. 62/641,092, filed Mar. 9, 2018, entitled COMPACT ABSORBENT GLASS MAT BATTERY, the entire contents of each of which is incorporated by reference herein in its entirety.

### FIELD

This application relates to the field of batteries. More specifically, this application relates to the field of lead acid batteries.

### BACKGROUND

Lead acid batteries are known. Lead acid batteries are made up of plates of lead and separate plates of lead dioxide, which are submerged into an electrolyte solution. The lead, lead dioxide and electrolyte provide a chemical means of storing electrical energy which can perform useful work when the terminals of the battery are connected to an external circuit.

Flooded or wet cell lead acid batteries are common and economical. These batteries require regular maintenance, e.g., refill of electrolyte. Such batteries often have a shorter cycle life than other lead acid batteries. For example, an Enhanced Flooded Battery (EFB) provides an improvement on cycle life and can withstand some of the cyclic demands of start-stop vehicles. EFB batteries are charged similar to standard flooded batteries and installed in a vertical position.

One type of lead acid battery is an AGM or Absorbent Glass Mat lead acid battery which is a sealed (e.g., maintenance-free), or more specifically a valve regulated battery in which the electrolyte is absorbed and retained in a mat that is wrapped around or interleaved with an electrode(s) or plate(s). AGM batteries are also known as recombinant batteries, that is, H2 and O2 generated during charging are recombined to water in the battery.

AGM lead acid batteries are advantageous over traditional starting, lighting and ignition (SLI) batteries, in that they are better suited to providing power in a vehicle with numerous electronic features or plug-in accessories. AGM batteries allow a greater depth of discharge, a faster recharge, and provide higher current than SLI and EFB batteries. AGM batteries are also a preferred solution for fuel saving start-stop vehicle technology.

Lead acid batteries for vehicles generally conform to an industry-standard “battery group size” which is a standard classification indicating features such as, among other things, physical battery dimensions. Standard battery group sizes are defined by various regional entities with a variety of different but equivalent nomenclature; i.e. in North America battery group size is assigned by the Battery Council International (BCI), Europe EN (European Norm), DIN (German industrial norm), and BS (British standard) are commonly used. In the Far East, Japanese Industrial Standard (JIS) is applied. Example designations include designations such as “H5”, “H6”, “H7”, “H8”, “H9” and so forth or “LN1”, “LN2”, “LN3”, “LN4”, and so forth. Table 1 illustrates the general dimensions and certain standard specifications of some of the noted designations:

TABLE 1

| EN “H” Size | H4 | H5 | H6 | H7 | H8 | H9 |
|---|---|---|---|---|---|---|
| EN “LN” size | LN1 | LN2 | LN3 | LN4 | LN5 | LN6 |
| BCI equivalent | 140 R | 47 | 48 | 94 R | 49 | 95 R |
| size | | | | | | |
| 20 hour | 50 Ah | 60 Ah | 70Ah | 80 Ah | 95 Ah | 105 Ah |
| Capacity C20 | | | | | | |
| cold cranking | 570 A | 680 A | 760 A | 800 A | 850 A | 950 A |
| amps CCA | | | | | | |
| width (mm) | 175 | 175 | 175 | 175 | 175 | 175 |
| length (mm) | 207 | 242 | 278 | 315 | 353 | 394 |
| height (mm) | 190 | 190 | 190 | 190 | 190 | 190 |
| volume (mm\hat{ }3) | 6882750 | 8046500 | 9243500 | 10473750 | 11737250 | 13100500 |
| Volume liters | 6.882750 | 8.04650 | 9.24350 | 10.47375 | 11.73725 | 13.10050 |

In the above table and as used herein:
A=Amps
Ah=Amp hour
BCI=Battery Council International
CCA=Cold Cranking Amps
C20=Energy a battery can deliver continuously for 20 hours at 80 degrees F. without falling below 10.5 volts
EN=European Norm
mm=millimeters

As each designation has a standard set of characteristics, the group size designation is often used to identify a type of battery that should be used in a particular vehicle application. For example, a battery group size may have a known or standard Cold Cranking Amperes (CCA) performance rating. A smaller group size typically correlates with a smaller CCA rating.

As indicated, lead acid batteries are made up of plates of lead (lead alloy grid+active material) and lead dioxide. In addition, lead is used as a conductive connector between cells and to the battery terminals. Lead is a heavy metal and considered to be toxic. Lead exposed to the environment is a potential source of contamination. Use of lead is therefore prohibited in many applications. Certain governmental bodies are advancing tighter regulation of lead in lead acid batteries, including the European Union and the State of California, United States of America, which have explored regulations about lead exposure as it relates to lead acid batteries. For example, the Department of Toxic Substances Control's (DTSC) in California is actively evaluating whether it should identify lead acid batteries as a Priority Product under the Safer Consumer Products (SCP) program. Unfortunately, when lead is removed from the battery, the resistance goes up and CCA goes down. Accordingly, a reduction in the amount of lead in a lead acid battery without compromising performance is desirable.

In addition, lead and lead acid batteries are generally heavy products. For example, a standard H4 or LN1 AGM lead acid battery may weigh approximately 14,930 grams while an H7 or LN4 AGM lead acid battery may weigh upwards of approximately 22,850 grams. In a vehicle, this weight impacts fuel efficiency and, in turn, vehicle emissions. Therefore, it is also desirable to reduce the weight of a lead acid battery in automotive applications without compromising performance of the battery.

Likewise, it would be advantageous to reduce the overall size of the lead acid battery without compromising performance to allow for use in other applications and to provide space for other vehicle components.

AGM has various advantages over flooded lead acid battery technology, such as but not limited to SLI and Enhanced Flooded Batteries (EFB). Examples include, but are not limited to: improved cycling vs flooded battery; lower water loss at under hood temperatures; better partial state of charge operation in stop-start duty; better charge acceptance after a stop-start event; good warm engine cranking during a restart event; greatly reduced electrolyte stratification in immobilized glass mat; and resistance to active mass sulfation. Moreover, the unspillable absorbed acid allows mounting the battery in different locations, such as for example, behind the engine firewall, in the passenger compartment or in the trunk.

Accordingly, a need exists for a battery, such as an AGM lead acid battery, that has a reduced amount of lead, a reduced physical size, and a reduced weight without compromising performance or with improved performance of the battery.

### SUMMARY

An AGM lead acid battery is disclosed which has an improved performance in a smaller battery group size or volume, and which includes less lead.

More specifically, a lead acid battery is disclosed that is a smaller compact battery that can deliver the higher power density than the larger traditional battery.

The battery comprises a container and one or more electrically connected cells in the container. The electrically connected cells are composed of or include a plurality of positive plates and plurality of negative plates, wherein an absorbent glass mat is interleaved between positive and negative plates from the plurality of positive plates and plurality of negative plates. Electrolyte is provided within the container. The battery has a gravimetric energy density ranging from 81 to 96 Amps per liter with a lead to weight performance ratio equal to or below 2.75 grams per Amp.

An LN1 AGM lead acid battery is also disclosed. The battery has a container and one or more electrically connected cells in the container formed by a plurality of positive plates and a plurality of negative plates, wherein an absorbent glass mat is interleaved between positive and negative plates from the plurality of positive plates and the plurality of negative plates. Electrolyte is provided within the container. The LN1 battery has a weight which is less than 17 kilograms and a cold cranking amp performance rating of 660 Amps. An LN2 AGM lead acid battery is also disclosed, having a weight which is less than 20 kilograms and a cold cranking amp performance rating of 720 Amps. An LN3 AGM lead acid battery is also disclosed, having a weight which is less than 22 kilograms and a cold cranking amp performance rating of 800 Amps. An LN4 AGM lead acid battery is also disclosed, having a weight which is less than 26 kilograms and a cold cranking amp performance rating of 850 Amps.

A lead acid battery is also disclosed which includes a container and one or more electrically connected cells in the container comprised by a plurality of positive plates and plurality of negative plates, wherein an absorbent glass mat is interleaved between positive and negative plates from the plurality of positive plates and plurality of negative plates; and electrolyte is provided within the container. The lead acid battery has a performance corresponding to a first standard battery group size, and a physical battery size corresponding to a second standard battery group size, which second standard battery group size is smaller than the first standard battery group size. A lead acid battery of the type disclosed herein may also have a performance corresponding to a standard battery group size and a lower lead content, smaller size, and less weight than the standard battery group size.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a perspective view of a vehicle having a compact AGM lead acid battery according to one or more examples of embodiments described herein.

FIG. 2 is a perspective view of a compact AGM lead acid battery according to one or more examples of embodiments described herein.

FIG. 3 is a perspective view of the compact AGM lead acid battery shown in FIG. 2, with the cover removed to show cell elements or plate sets therein.

FIG. 4 is an exploded view of a compact AGM lead acid battery according to one or more examples of embodiments described herein.

FIG. 5 is a side elevation view of a cell element or plate set of a compact AGM lead acid battery according to one or more examples of embodiments described herein.

FIG. 6 is an elevation view of a battery grid for use with a compact AGM lead acid battery according to one or more examples of embodiments described herein.

FIG. 7 is an additional elevation view of a battery grid for use with a compact AGM lead acid battery according to one or more examples of embodiments described herein.

FIG. 8 is an elevation view of one or more examples of a plate having an imprint on the plate surface.

FIG. 9 is a graph showing performance in Cold Cranking Amperes (CCA) across battery group sizes for both a standard AGM lead acid battery and a compact AGM lead acid battery according to one or more examples of embodiments described herein.

FIG. 10 is a graph showing lead (Pb) content by weight percent of the grid and paste in an AGM lead acid battery across battery group sizes for both a standard AGM lead acid battery and a compact AGM lead acid battery according to one or more examples of embodiments described herein.

FIG. 11 is a graph showing gravimetric energy density, namely, Cold Cranking Amp (CCA) performance in Amps per liter or volume of AGM lead acid battery, across battery group sizes for both a standard AGM lead acid battery and a compact AGM lead acid battery according to one or more examples of embodiments described herein.

FIG. 12 is a graph showing the lead (Pb) weight to performance (CCA) ratio in an AGM lead acid battery across battery group sizes for both a standard AGM lead acid battery and a compact AGM lead acid battery according to one or more examples of embodiments described herein.

FIG. 13 is a graph showing the difference in battery weight between a standard AGM lead acid battery and a compact AGM lead acid battery according to one or more examples of embodiments described herein over the difference in battery performance (CCA) between a standard AGM lead acid battery and a compact AGM lead acid battery according to one or more examples of embodiments described herein plotted across battery group sizes.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

A lead acid battery is described herein which incorporates the advantages of an AGM lead acid battery with less weight and a smaller size. The compact battery described herein uses less lead to achieve improved cycle life and higher CCA, overcoming many of the drawbacks of EFB lead acid batteries and traditional AGM lead acid batteries, and may provide such advantages in a smaller size.

Referring to the Figures, a battery 100 is disclosed, and in particular a rechargeable battery, such as, for example, a lead acid battery. According to one or more examples of embodiments, the battery 100 is a lead acid storage battery. Various embodiments of lead acid storage batteries may be either sealed (e.g., maintenance-free) or unsealed (e.g., wet). According to one or more examples of embodiments, the lead acid storage battery 100 described herein is preferably a sealed lead acid battery or AGM lead acid battery and, to this end, may include an absorbent glass mat (AGM). While specific examples are described and illustrated, the battery may be any secondary battery suitable for the purposes provided.

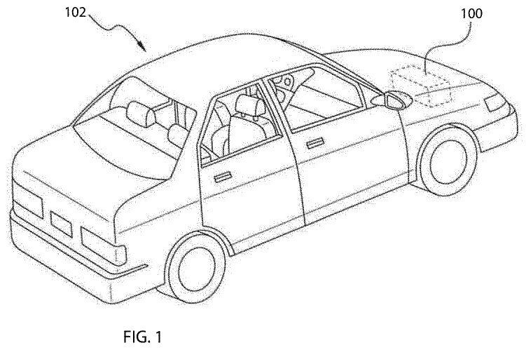

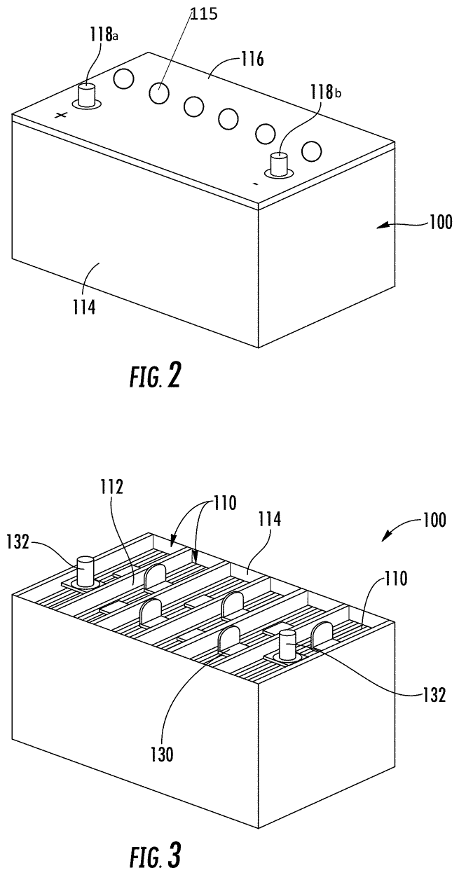

A battery 100 is provided and shown in a vehicle 102 in FIG. 1. Referring to FIGS. 2-4, the battery 100 is an AGM lead acid battery having positive and negative plates 104, 106 which are separated by an absorbent glass mat 108 (also referred to as “AGM”) that absorbs and holds the battery's acid or electrolyte and prevents it from flowing freely inside the battery 100. The working electrolyte saturation is at some value below 100% saturation to allow recombinant reactions of hydrogen and oxygen. More specifically, the AGM lead acid battery 100 includes several cell elements 110 which are provided in separate compartments 112 of a container or housing 114. The element stack may be compressed during insertion reducing the thickness of the separator for the purpose of improved performance. An electrolyte, which is typically sulfuric acid, may be provided within the container 114, and/or absorbed in the absorbent glass mat separator 108. A cover 116 is provided for the container or housing 114 and may be sealed to the housing. In various embodiments, the cover 116 includes battery terminals 118 (e.g. 118a—pos, 118b—neg.). The battery cover 116 may also include one or more filler hole caps and/or vent assemblies 115. For example, six vent assemblies 115 or valves may be provided associated with the six compartments 112 of the container 114 to allow venting of each compartment.

Referring to FIGS. 3-7, the plates 104, 106 include electrically-conductive positive or negative grids or current collecting members 120, 122. Positive paste 124 is provided on the positive grid 120 and negative paste 126 is provided on the negative grid 122. More specifically, the positive plate 104 includes a positive grid 120 having or supporting a positive active material or paste 124 thereon, and in some examples of embodiments may include a pasting paper or a scrim 133 (e.g., a woven or non-woven sheet material comprised of fibers); and the negative plate 106 includes a negative grid 122 having or supporting a negative active material or paste 126 thereon, and in some examples of embodiments may include a pasting paper or a scrim 133. Positioned between the positive and negative plates 104, 106 is a separator 108. In a retained electrolyte-type battery system such as described herein, the separator may be a porous and absorbent glass mat (AGM) 108. In some examples, the absorbent glass mat 108 may also be used with an additional separator.

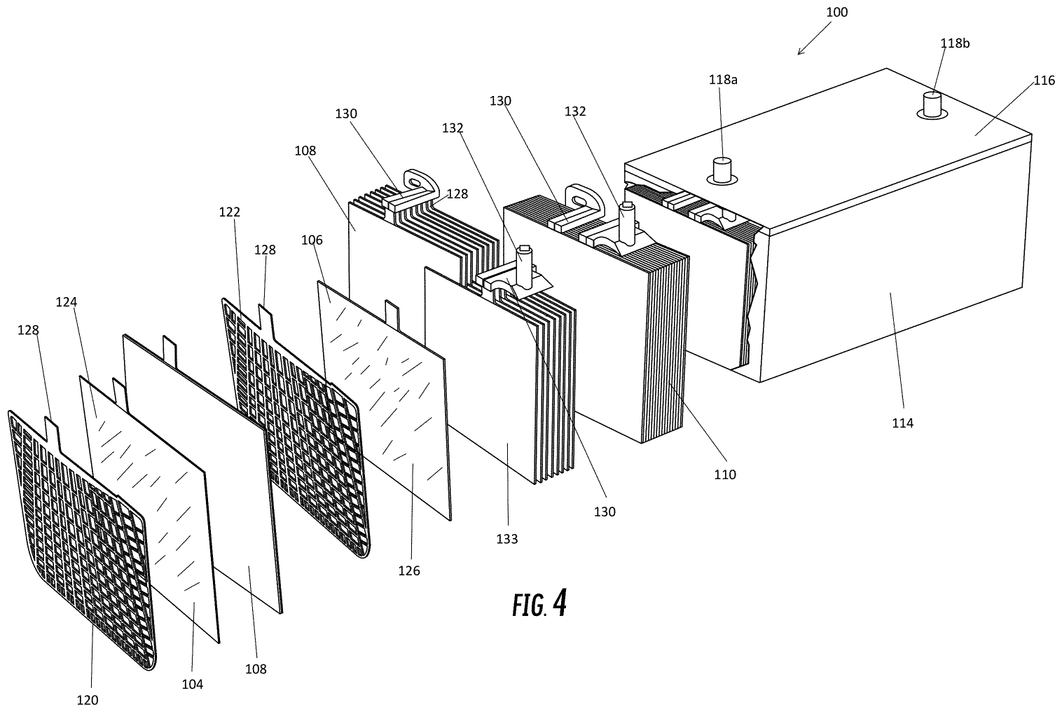

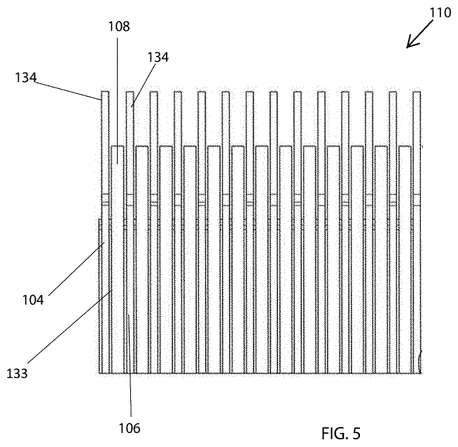

A plurality of positive plates 104 and a plurality of negative plates 106 (with separators 108) generally make up at least a portion of the electrochemical cell 110. As indicated, each plate set or cell may include one or more positive plates 104 and one or more negative plates 106. Thus, the battery 100 includes a positive plate 104 and a negative plate 106, and more specifically a plurality of positive plates and a plurality of negative plates. Referring to FIG. 3, a plurality of plate sets or books or cells 110 may be electrically connected, e.g., electrically coupled in series or other configuration, according to the capacity of the lead acid storage battery 100. Each grid 120, 122 has a lug 128 (see FIGS. 4, 7). In FIGS. 3 and 4 one or more cast-on straps or intercell connectors 130 are provided which electrically couple the lugs 128 of like polarity in a plate set or cell 110 and to connect other respective plate sets or cells 110 in the battery 100. The cast-on straps or intercell connectors 130 may be formed of a lead or lead alloy according to common commercial practices and may be arranged to connect the lugs 128 of the respective cells 110 in series according to known, traditional arrangements (see FIGS. 3-4). One or more positive and one or more negative terminal posts 132, and in particular one positive terminal post 132 and one negative terminal post 132 (FIGS. 2-4) may also be provided, and electrically connected to the cells through the various intercell connectors 130. Such terminal posts 132 typically include portions which may extend through the cover 116 and/or container wall 114, depending upon the battery design. It will be recognized that a variety of terminal arrangements are possible, including top, side, front or corner configurations known in the art.

As described in various embodiments herein, the positive and negative plates 104, 106 (FIG. 4) are paste-type electrodes. Thus, each plate 104, 106 comprises a grid 120, 122 pasted with an active material 124, 126. More specifically, the paste-type electrode includes a grid 120, 122 which acts as a substrate and an electrochemically active material or paste 124, 126 provided on the substrate. In other words, each plate 104, 106 includes a grid 120, 122 that supports an electrochemically active material 124, 126. The grids, including a positive grid 120 and a negative grid 122, provide an electrical contact between the positive and negative active materials 124, 126 or paste which may serve to conduct current.

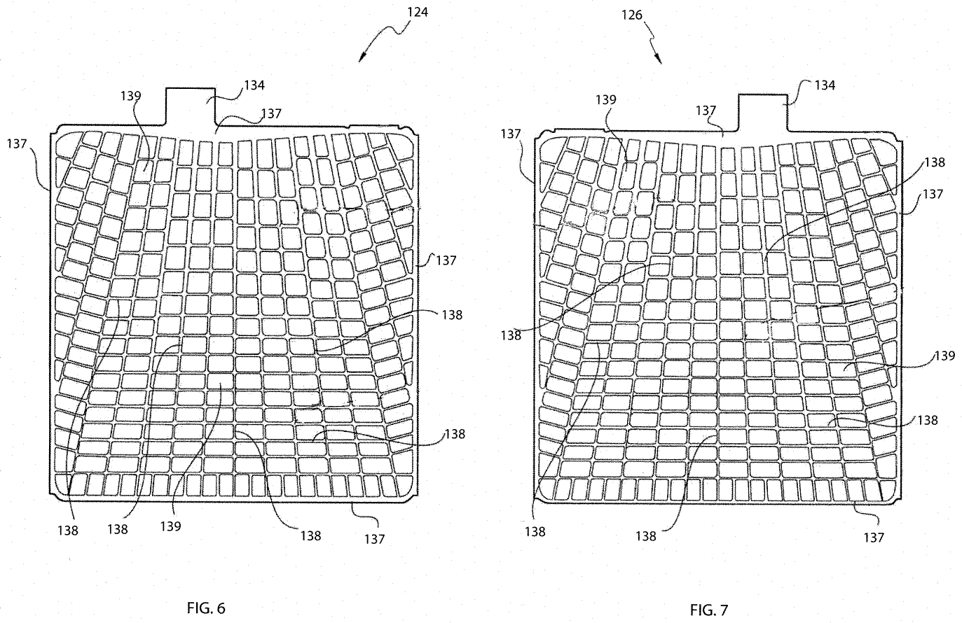

In one or more examples of embodiments, the grid(s) 120, 122 may have a radial configuration similar to those disclosed in U.S. Pat. Nos. 5,582,936; 5,989,749; 6,203,948; 6,274,274; and 6,953,641 8,709,664, which are hereby incorporated by reference herein. To this end, the grids 120, 122 may be stamped or punched fully framed grids 120, 122 having a radial arrangement of grid wires 134 (see FIGS. 6-7). While specific examples or radial patterns are provided, variations thereon may also be acceptable for the intended purposes. According to one or more examples of embodiments, the grids 120, 122 may be the same or similar. In one example, both the positive grid(s) 120 and the negative grid(s) 122 may have the same or similar configuration or arrangement. However, it is contemplated that the grids may differ. For example, the positive grid 120 may be a stamped or punched fully framed grid having a radial arrangement of grid wires 134 and the negative grid 122 may be concast or, for example, expanded metal or gravity cast, or the negative grid may be stamped or punched and fully framed but with a different pattern of grid wires from the positive grid. While specific examples of grid wire arrangements, patterns, and grid types are described for purposes of example, the invention is not limited thereto and any grid structure or arrangement suitable for the purposes of the battery may be substituted in place of the described grids.

According to one or more examples of embodiments, the grid material may be composed of lead (Pb) or a lead alloy (or any conductive substrate, i.e. carbon fiber). The grid alloy may be a common commercially available alloy, and to this end may comprise or include one or more of lead, tin, silver, calcium, antimony, etc. in a variety of combinations and percentages. Both the positive grid 120 and the negative grid 122 may be formed of the same material. It is contemplated, however, that material composition may also vary between the positive grid and negative grid.

In one example of embodiments, the positive and negative grids 120, 122 may be formed of different thickness. However, it is contemplated that the grids 120, 122 may be of the same thickness. The thickness of each grid 120, 122 may be varied based upon desired manufacturing and performance parameters. For instance, thickness or processability or corrosion resistance may be considered, as well as minimum manufacturing requirements or minimum requirements for paste adhesion, or other suitable parameters. However, according to one or more examples, the grid material may comprise a minimal thickness.

Corrosion in the positive grid may be counteracted by an increased thickness in the positive grid. Increased thickness of the positive grid resists grid growth as well as the likelihood of grid or battery failure due to high heat. Negative grids, and in particular AGM negative grids which are taller in height, may be difficult to paste when reduced in thickness. As indicated in the present case, however, preferably the grids 120, 122 are reduced in thickness over standard or traditional AGM lead acid battery grids such that, when formed into battery plates, additional plates 104, 106 may be inserted into the battery 100 as described herein. For example, one or more battery grids may be reduced in thickness by 0.1 to 0.5 millimeters. In one or more examples of embodiments, the thickness of the negative grid may be less than the thickness of the positive grid. In fact, in one or more examples of embodiment, the thickness of the negative grid may be very thin as compared to a standard or conventional grid. To this end, the negative grid may have a thickness ranging from 0.65 mm to 0.75 mm or approximately 0.65 mm to approximately 0.75 mm. In one example, lug width may also vary depending on manufacturing criteria or other factors, which may impact overall grid weight. For example, a wider lug (e.g., greater than 13 mm) may be used in some examples to help improve CCA performance or due to manufacturing specifications.

In various examples, by reducing the amount of lead in the grid 120 and/or 122, or the thickness of the grid, the overall weight of the grid as well as the battery 100 including the one or more such grids is reduced.

While specific examples are provided herein for purposes of illustration, variations thereon may be made to provide grid dimensions suitable for the particular application. For instance, the weight of the grid, and ultimately the weight of the resulting battery 100 may be varied.

In more detail, the positive plate 104 contains a metal (e.g., lead alloy) grid 120 with lead dioxide active material or paste 124 thereon. Examples of lead-containing compositions which may be employed in the positive paste include, but are not limited to, finely-divided elemental Pb, PbO (“litharge” or “massicot”), Pb₃O₄ (“red lead”), PbSO₄ (“lead sulfate” with the term “PbSO₄” being defined to also include its associated hydrates, and basic sulfates: 1PbO.PbSO4, 3PbO.PbSO4.H2O, 4PbO.PbSO4), and mixtures thereof. Different materials may be used in connection with the lead-containing paste composition, with the present invention not being restricted to any particular materials or mixtures (added fibers, or other constituents). These materials may be employed alone or in combination as determined by numerous factors, including for example, the intended use of the battery 100 and the other materials employed in the battery.

The negative plate 106 may be composed of a metal (e.g., lead alloy) grid 122 with a spongy lead active material or paste 126 thereon. The negative paste 126 may, in a preferred embodiment, be substantially similar to the positive paste 124 but may also vary. Example lead-containing compositions which may be employed in the negative paste include but are not limited to finely-divided elemental Pb, PbO (“litharge” or “massicot”), Pb₃O₄ (“red lead”), PbSO₄ (“lead sulfate” with the term “PbSO₄” being defined to also include its associated hydrates, and basic sulfates: PbO.PbSO4, 3PbO.PbSO4.H₂O, 4PbO.PbSO4) and mixtures thereof. In addition, the negative active material may also contain fiber and “expander” additives to maintain the active material structure and improve performance characteristics, among other reasons. These materials may be employed alone or in combination as determined by numerous factors, including for example, the intended use of the battery 100 and the other materials employed in the battery.

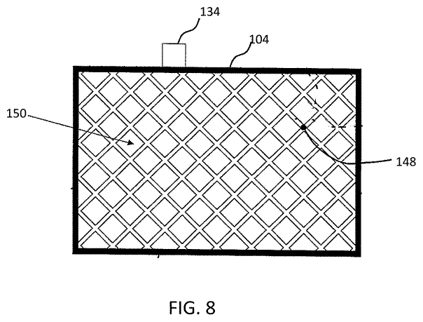

In one or more examples of embodiments, the pasted plates (with or without surface scrim 133) may be imprinted, or have an imprint 148 on the surface 150, such as a “waffle” print (such as shown in FIG. 8) or “riffle” print, to provide, for example, a plurality of grooves such as disclosed in United States Patent Publication No. 2015/0104715, the entire contents of which is hereby incorporated by reference in its entirety. As disclosed in said publication, the imprint or grooves may assist in electrolyte flow and gas (air, CO2, O2, H2) removal, among other benefits.

As indicated, separator material may be provided between each positive plate 104 and negative plate 106. The separator may be an absorbent glass mat 108, and in one or more examples of embodiments may be wrapped around a portion of, or interleaved with/provided between one (or both) of the positive and negative plates 104, 106. A single or double layer of separator or AGM may be employed. The absorbent glass mat 108 may be constructed similar to and/or of a similar material to traditional absorbent glass mat separators, including thin glass fibers woven into a mat (or more commonly non-woven deposited fibers). According to one or more examples of embodiments, the absorbent glass mat material may be thinner (or more highly compressed). In one example, the absorbent glass mat material may include less fiber material so as to reduce the thickness of the absorbent glass mat separator 108. In one or more examples of embodiments, the separator or absorbent glass mat separator 108 may comprise 100% glass fiber. In an alternative example of embodiments, the separator or absorbent glass mat separator 108 may comprise a glass fiber plus a second or additional fiber of a different type of material.

In one or more preferred examples of embodiments, the compact AGM lead acid battery 100 has an increased number of plates 104, 106 (of one or both polarities) over a conventional AGM lead acid battery in a given battery group size. Table 2, below, shows a representative example of the number of positive plates 104 and the number of negative plates 106 in each plate set or cell element 110 in example compact AGM lead acid batteries and example standard AGM lead acid batteries. As shown, in one example of a standard or conventional “LN1” AGM lead acid battery, five (5) positive plates and six (6) negative plates may be provided in stacks or plate sets or books or cell elements for producing a battery having a predetermined voltage, for example a 12-volt battery in an vehicle. In an alternative example of a standard or conventional “LN3” AGM lead acid battery, seven (7) positive and eight (8) negative plates may be provided in stacks or plate sets or cell elements. In comparison, in one or more examples of embodiments of a compact AGM lead acid battery of the type described herein, additional plates may be added to each set. For example, as shown in Table 2, an “LN1” AGM lead acid battery may have six (6) positive and seven (7) negative plates provided in the plate groups or books or cells; and an “LN3” AGM lead acid battery may have eight (8) positive plates and nine (9) negative plates in the plate sets or books or cells. Additional examples are shown in Table 1. While specific examples are provided, the number of stacks or plate sets may be varied. It will also be obvious to those skilled in the art after reading this specification that the size and number of plates in any particular stack (including the size and number of the individual grids), and the number of stacks used to construct the battery may vary depending upon the desired end use. Additionally, while LN1/H4, LN2/H5, LN3/H6, LN4/H7 are specifically described herein and illustrated in the examples, one of skill in the art would appreciate that the same principles may be applied to additional or alternative size batteries, such as for example, LN5/H8 and LN6/H9, etc.

As additional plates are provided in the compact AGM lead acid battery, preferably, the plates 104 and/or 106 in the compact AGM lead acid battery 100 described herein are thinner than those provided in a standard or conventional AGM lead acid battery as previously discussed, and the separator 108 provided in the compact AGM lead acid battery 100 described herein may also be thinner (or more highly compressed) than those provided in a conventional AGM lead acid battery, such that the assembly with additional plates and separators may fit within a conventional AGM lead acid battery container 114. As additional plates are used in the battery 100, additional absorbent glass mats 108 may also be provided to separate the plates.

Advantageously, the combination of the above-described additional plates and thinner plates, provides an increase in surface area for the same or approximately the same weight and/or size of battery. (Surface area in this case is calculated by height/width/number of plates in battery). This leads to, among other things, improved CCA performance.

### EXAMPLES

The following Examples are an illustration of one or more examples of embodiments of carrying out the invention and are not intended as to limit the scope of the invention. The AGM lead acid battery 100 having a compact design as described herein may have one or more of the following characteristics.

### Example 1

An example comparison of a compact AGM lead acid battery of the type described herein versus a standard or conventional AGM lead acid battery is represented in Table 2.

TABLE 2
EXAMPLE COMPARISON DATA OF ONE EXAMPLE COMPACT AGM LEAD
ACID BATTTERY AND AN EXAMPLE STANDARD AGM LEAD ACID BATTERY

| BATTERY | | | |
|---|---|---|---|
| GROUP SIZE | COMPACT AGM | STANDARD AGM | Difference |
| Plate count | (pos./neg.) | (pos./neg.) | (pos./neg.) |
| LN1 | 6/7 | 5/6 | 1/1 |
| LN2 | 7/8 | 6/7 | 1/1 |
| LN3 | 8/9 | 7/8 | 1/1 |
| LN4 | 9/10 | 8/9 | 1/1 |
| Grid technology | (pos./neg.) | (pos./neg.) | (pos./neg.) |
| Option 1 | PF/PFo | PF/Concast | PFo neg. |
| Option 2 | PF/PFo | PF/PFo | No change |
| Grid thickness | | | |
| Positive | 0.90 mm | 1.05 mm | 0.15 mm |
| Negative | 0.70 mm | 0.90 mm | 0.20 mm |
| Plate thickness | | | |
| Positive plate | 1.55 mm | 1.95 mm | 0.40 mm |
| Negative plate | 1.30 mm | 1.44 mm | 0.14 mm |
| Grid weight - % | | | |
| Reduction | | | |
| Positive | | | 10-15% |
| Negative | | | 20-25% |
| Active Material | | | |
| weight - % | | | |
| Reduction | | | |
| Positive | | | 15-25% |
| Negative | | | 1-5% |
| Battery weight | | | |
| LN1 | 15.07 kg | 14.93 kg | −0.14 kg |
| LN2 | 17.47 kg | 17.54 kg | 0.07 kg |
| LN3 | 19.96 kg | 20.23 kg | 0.27 kg |
| LN4 | 22.41 kg | 22.85 kg | 0.44 kg |
| Plate Dimension | | | |
| Positive and | 13.0 cm (height) | 13.0 cm (height) | No change |
| Negative | 14.8 cm (width) | 14.8 cm (width) | No change |
| CCA (cold | | | |
| cranking amp) | | | |
| LN1 | 660 A (680 A) | 570 A | 90 A |
| LN2 | 720 A (760 A) | 660 A (680 A) | 60 A |
| LN3 | 800 A | 720 A (760 A) | 80 A |
| LN4 | 850 A | 800 A | 50 A |
| | (height * width * | | |
| Battery | length) | (height * width * | |
| dimensions | Volume = | length) | |
| LN1 | 190 mm * 175 mm * | 190 mm * 175 mm * | No change |
| | 207 mm = 6.9 liter | 207 mm = 6.9 liter | |
| LN2 | 190 mm * 175 mm * | 190 mm * 175 mm * | No change |
| | 242 mm = 8.0 liter | 242 mm = 8.0 liter | |
| LN3 | 190 mm * 175 mm * | 190 mm * 175 mm * | No change |
| | 278 mm = 9.2 liter | 278 mm = 9.2 liter | |
| LN4 | 190 mm * 175 mm * | 190 mm * 175 mm * | No change |
| | 315 mm = 10.5 liter | 315 mm = 10.5 liter | |
| Cell width | | | |
| LN1 | 28.8 mm | 28.8 mm | No change |
| LN2 | 34.6 mm | 34.6 mm | No change |
| LN3 | 40.6 mm | 40.6 mm | No change |
| LN4 | 46.6 mm | 46.6 mm | No change |

Note:
PF refers to PowerFrame ® grids available from Johnson Controls, PLC, Milwaukee, WI.
“PFo” refers to alternative PowerFrame grids available from Johnson Controls, PLC, Milwaukee, WI.
Note, while not included in Table 2, comparatively, a standard LN5/H8 AGM battery may have a weight of 26.62 kg, a length of 381 mm, a width of 175 mm, and a height of 192 mm.

As can be seen in Table 2, while the overall battery dimensions are similar, the compact AGM lead acid battery includes a greater number of plates (both positive and negative) than the standard or conventional AGM lead acid battery. The grids of the compact AGM lead acid battery are also of a lesser weight and are thinner than the grids of the standard AGM lead acid battery. Moreover, the plates of the compact AGM lead acid battery are also thinner.

Cold Cranking Amps (CCA) is a rating used in the battery industry to define a battery's ability to start an engine in cold temperatures. For example, the rating refers to the number of amps a 12-volt battery can deliver at 0 degrees Fahrenheit for 30 seconds while maintaining a voltage of at least 7.2 volts. The higher the rating the greater the starting power of the battery. As is known, variations in individual batteries may vary and battery starting power deteriorates as a battery ages. Other standards may also be available to rate performance.

Notably, the compact AGM lead acid battery has a CCA performance rating which is greater than the standard AGM lead acid battery and, in fact, has a CCA performance rating which corresponds to the next level battery group size (e.g., a compact AGM lead acid battery which is an “LN1” performs approximately the same duty as a standard “LN2” AGM lead acid battery, as well as an LN2 EFB battery, and so forth). Using the data shown in Table 2, the compact AGM battery has a percentage improvement in CCA performance rating over the standard AGM battery or EFB battery ranging from 105% to 115% or more, examples of which are as follows:

LN1=(660 A/570 A)*100=115%

LN2=(720 A/660 A)*100=109%

LN3=(800 A/720 A)*100=111%

LN4=(850 A/800 A)*100=106%

### Example 2

In one or more examples of embodiments, a compact AGM lead acid battery of the type described herein may have a decrease in current density. Discharge current density may be understood as cold crank amperes divided by plate surface area. For example:

$$Current Density = \frac{C C A}{Number of Pos . Plates * Area of Pos . Plates}$$

Lower current density is beneficial for CCA performance. According to the equation, by increasing the plate count by one plate pair, such as may be accomplished with the compact AGM lead acid battery, the current density will be decreased. That is, there is decreased current density due to an increase in surface area of positive plates. Current density may also be decreased by a change in other parameters.

A non-limiting example of the foregoing is provided below in reference to Table 2:

Compact AGM lead acid battery, Battery Group Size—“LN3” or “H6”:
CCA=800 A; Plate count: 8 positive/9 negative; 2 opposed plate surfaces
Current density=800 A/2(192.4 cm2*8)=800 A/3078.4 cm2=0.2599 A/cm2 discharge

Standard AGM lead acid battery, Battery Group Size—“LN3” or “H6”:
CCA=720 A; Plate count: 7 positive/8 negative; 2 opposed plate surfaces
Current density=720 A/2(192.4 cm2*7)=720 A/2693.6 cm2=0.2673 A/cm2 discharge
   As can be seen by the above calculations, in the same Battery Group Size, the current density (0.2599 A/cm2 vs. 0.2673 A/cm2) is less in the compact AGM lead acid battery due to there being an increase in the number of plates.

### Example 3

An alternative example comparison of a compact AGM lead acid battery of the type described herein versus a standard or conventional AGM lead acid battery is represented in Table 3. In the illustrated example, grid as a weight percent of the battery, paste as a weight percent of the battery, and lead (grid and paste) as a weight percent of the battery, are shown.

TABLE 3

| | | | Pb WT. % of |
|---|---|---|---|
| | GRID WT. % | PASTE WT. % | BATTERY |
| COMPACT | | | |
| BATTERY | | | |
| SIZE/TYPE | | | |
| LN1 | 20.7% | 42.8% | 63.6% |
| LN2 | 20.7% | 42.7% | 63.3% |
| LN3 | 20.5% | 42.4% | 62.9% |
| LN4 | 20.5% | 42.2% | 62.6% |
| STANDARD | | | |
| BATTERY | | | |
| SIZE/TYPE | | | |
| LN1 | 21.6% | 41.8% | 63.4% |
| LN2 | 21.7% | 42.1% | 63.9% |
| LN3 | 21.8% | 42.2% | 64.0% |
| LN4 | 21.9% | 42.4% | 64.3% |

It is noted that the lead (Pb) (grid and paste) weight percent or percentage amount of lead, by weight, in the battery is an approximation that assumes the two primary sources of lead in the AGM lead acid battery are the grid(s) and the paste(s). However, it is understood that additional battery components, such as the cast-on straps, terminals, and bushings are also often composed of lead and may further contribute to the overall lead content and percent by weight in the lead acid battery.

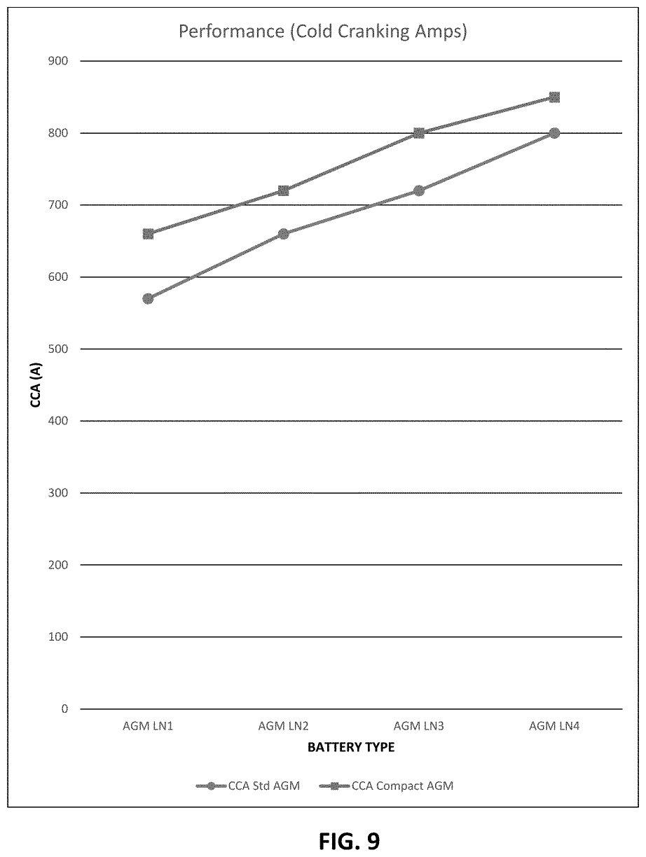

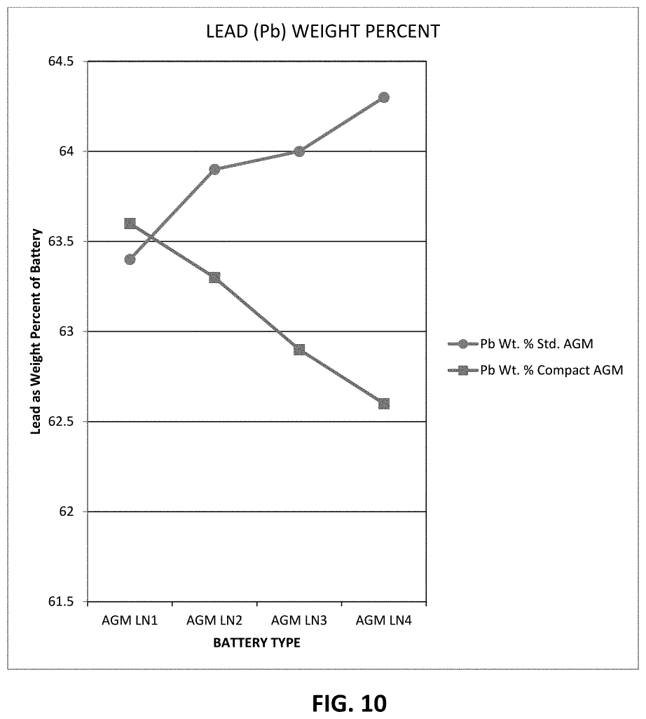

As may be seen, the battery according to one or more examples of embodiments, is approximately the same or reduced in lead content over standard AGM batteries, yet provides the same or better performance (CCA). More specifically, as can be seen in comparing FIGS. 9-10, showing a graph of performance data (in Cold Cranking Amps) of a compact AGM lead acid battery and a standard AGM lead acid battery (FIG. 9) and a graph of the amount of lead (Pb) (grid plus paste) by weight percent in said batteries (FIG. 10), the percentage amount of lead (Pb) in a battery is reduced as compared to the standard AGM lead acid battery. Surprisingly, despite having less lead, the compact AGM lead acid battery performs at a higher level, and in particular with a higher CCA than the standard AGM lead acid battery, that is, the battery has an improved engine starting power. The smaller compact battery can deliver the higher power density than the larger traditional battery.

### Example 4

In another example of embodiments, the battery performance (CCA) per volume in a compact AGM lead acid battery of the type described herein is also improved over a standard AGM lead acid battery. In particular, the compact AGM battery has a gravimetric energy density (kW/liter or CCA amps/liter) which is between approximately 5 A/liter and 15 A/liter greater than the standard AGM battery, an example of which is shown below in Table 4. The following equation is used to illustrate an approximate performance per unit of volume in an AGM lead acid battery.

$$Performance \text{/} Volume$$

$$\frac{Performance ( Amps )}{Volume ( liter )} = ( \frac{C C A}{( \frac{\begin{matrix}LengthBattery * HeightBattery * \\ WidthBattery\end{matrix}}{1000000} )} )$$

### Where:

### CCA=Cold Cranking Amperes (A)

HeightBattery=190 mm (constant)
WidthBattery=175 mm (constant)
LengthBattery=X (where X=length of the AGM lead acid battery container at a given battery group size)

TABLE 4

| | Compact AGM | Standard AGM | |
|---|---|---|---|
| | Energy Density | Energy Density | |
| Battery | (A/liter) | (A/liter) | Difference |
| LN1 | 660 A/6.9 liter = 95.7 | 570 A/6.9 liter = 82.6 | 13.1 A/liter |
| | A/liter | A/liter | |
| LN2 | 720 A/8.0 liter = 90.0 | 660 A/8.0 liter = 82.5 | 7.5 A/liter |
| | A/liter | A/liter | |
| LN3 | 800 A/9.2 liter = 87.0 | 720 A/9.2 liter = 78.3 | 8.7 A/liter |
| | A/liter | | |
| LN4 | 850 A/10.5 liter = | 800 A/10.5 liter = | 4.8 A/liter |
| | 81.0 A/liter | 76.2 A/liter | |

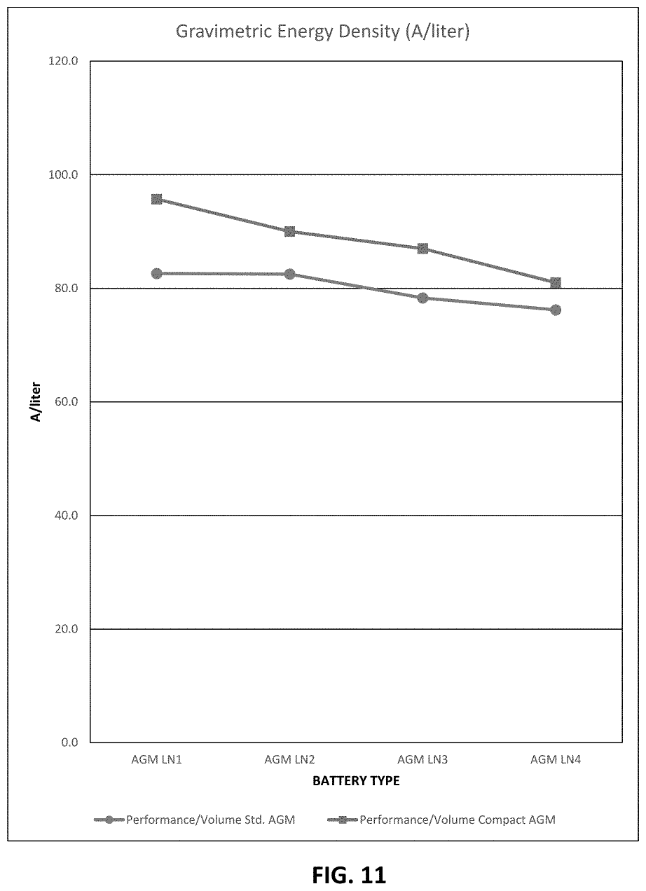

The results of the application of data from Table 2 to the above equation are shown in Table 4 and FIG. 11, which is a graph of performance (CCA) over a unit volume, showing the difference and improvement in performance of a compact AGM lead acid battery over a standard AGM lead acid battery. As may be seen in reference to FIG. 11 and Table 4, the battery according to one or more examples of embodiments has a Performance (CCA)/Volume (liters), namely, a gravimetric energy density, which is improved over existing AGM batteries. In comparison, a standard AGM battery has a lower performance/volume with the same or greater grid, paste, and lead content.

### Example 5

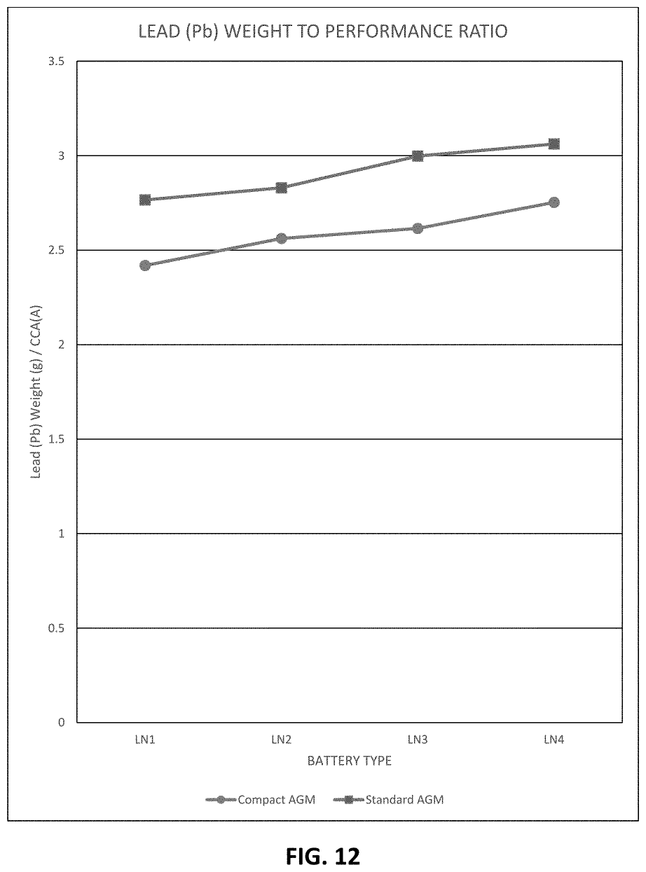

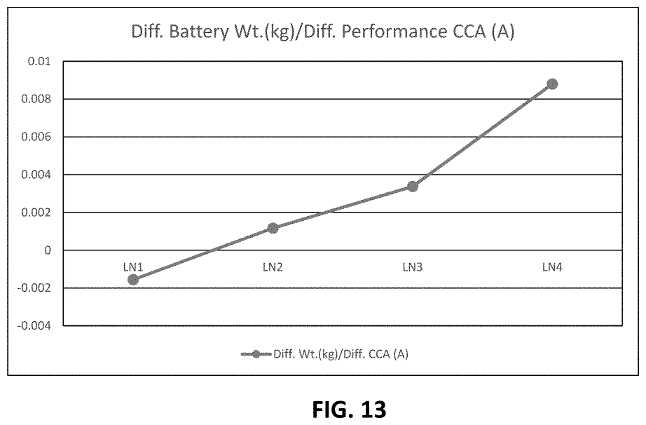

Referring to FIGS. 12-13, the improvement in the approximate lead (Pb) weight to performance ratio is shown for the compact AGM battery as compared to a standard AGM lead acid battery.

The approximate values shown in FIG. 12 are provided in Table 5 below for each battery type or group size.

TABLE 5

| | Compact AGM | Standard AGM |
|---|---|---|
| | (g/CCA(A)) | (g/CCA(A)) |
| LN1 | 2.42 | 2.77 |
| LN2 | 2.56 | 2.83 |
| LN3 | 2.62 | 3.00 |
| LN4 | 2.75 | 3.06 |

As can be seen, in each case, the compact AGM battery performs at approximately 10% variation from the standard AGM battery.

Referring to FIGS. 9, 13 and Table 2, the compact AGM lead acid battery performs (in CCA) above the standard AGM lead acid battery as the difference in battery weight between the compact AGM lead acid battery increases with group size. As can be seen, the compact AGM lead acid battery provides significant advantages in weight reduction with better cold crank performance. Similar advantages are also seen when compared to an EFB lead acid battery. This improved performance with less lead leads to better fuel economy for a vehicle; a reduction in lead content which is often considered a toxic substance; and raw material cost saving.

According to one or more examples of embodiments, and as can be seen by the examples set forth above, the battery size and amount of lead in a battery may be reduced without loss of power output, such as CCA. According to one or more further examples of embodiments, for a fixed battery size and separator compression, the power (e.g., CCA) may be increased without an increase in lead, and in fact a slight decrease. Moreover, in the event of a group downsize, the battery employed in actual use will include less lead, less weight, and less size simply by being a smaller battery group size (smaller overall container and less weight).

Advantageously, the additional plates provided within the battery provide more active surfaces for the chemical reaction necessary to supply power. In addition, by adding a plate, the internal resistance goes down while the efficiency goes up. That is, the inner resistance of the battery is improved (e.g., lower), which is beneficial to start-stop vehicle and other plug-in automotive technologies. Improvements are also gained in the cold cranking amperage (CCA) as well as the voltage during a cold cranking discharge, which may be higher in some examples of such batteries. In addition to the above-noted advantages, a battery may be provided which has the same or similar CCA rating as a traditional AGM battery, but may be reduced in weight and package size, resulting in various cost savings to both the manufacturer and the consumer. The battery described herein may be more capable of supporting higher electrical loads and provide improved charge acceptance and deep cycling to support demanding cycling strategies and high temperature performance, among others, i.e. Partial state of charge operation (PSoC).

According to one or more examples of embodiments, a group size downsize (a battery of a lower size class may be used) may also be accomplished by space and/or weight reduction which may be achieved. This may also be accomplished without compromising performance.

Advantageously, the battery disclosed herein may provide the opportunity to replace standard SLI and/or EFB batteries through AGM. In fact, a battery having one or more of the features described herein may have lower weight, smaller size, and higher cold cranking than current AGM and EFB lead acid batteries. In addition, battery weight contributes to overall vehicle weight, which can impact vehicle performance. Therefore, a lighter weight battery assists in vehicle performance. For example, vehicle fuel efficiency and/or reduction in CO₂ emission may be gained by use of the battery disclosed herein due to, among other reasons, lower weight and/or the opportunity to operate the battery in a Partial State of Charge (PSoC) due to for example regenerative braking. The smaller size battery also allows for more flexibility in vehicle design. Additionally, a leak proof design (e.g., acid may be stored in the AGM separator and the battery is sealed) provides an opportunity to install the battery in a variety of locations and orientations, including, but not limited to in a passenger compartment, or in the trunk, removing the battery from the engine compartment allows it to avoid high under the hood temperatures—prolonging useful life.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A lead acid battery comprising:
a container;
one or more electrically connected cells in the container formed by a plurality of positive plates and a plurality of negative plates, wherein an absorbent glass mat is interleaved between positive and negative plates from the plurality of positive plates and the plurality of negative plates;
electrolyte within the container; and
a gravimetric energy density ranging from 81 to 96 Amps per liter with a lead to weight performance ratio equal to or below 2.75 grams per Amp.

2. The lead acid battery of claim 1, wherein the cells include a greater number of positive plates, negative plates, and absorbent glass mats than a battery of a standard battery group size based upon a volume of the container.

3. The lead acid battery of claim 1, wherein the plurality of positive plates and negative plates comprise grids having a radial grid pattern with an active material thereon.

4. The lead acid battery of claim 1, wherein at least the positive plates or negative plates have an imprinted pattern on a surface.

5. An LN1 lead acid battery comprising:
a container;
one or more electrically connected cells in the container formed by a plurality of positive plates and a plurality of negative plates, wherein an absorbent glass mat is interleaved between positive and negative plates from the plurality of positive plates and the plurality of negative plates; and
electrolyte within the container;
wherein the battery has a weight which is less than 17 kilograms and a cold cranking amp performance rating of 660 Amps.

6. The lead acid battery of claim 5, wherein the cells include a greater number of positive plates, negative plates, and absorbent glass mats than a battery of a standard battery group size based upon a volume of the container.

7. The lead acid battery of claim 5, wherein the plurality of positive plates and negative plates comprise grids having a radial grid pattern with an active material thereon.

8. The lead acid battery of claim 5, wherein at least the positive plates or negative plates have an imprinted pattern on a surface.

9. An LN2 lead acid battery comprising:
a container;
one or more electrically connected cells in the container formed by a plurality of positive plates and a plurality of negative plates, wherein an absorbent glass mat is interleaved between positive and negative plates from the plurality of positive plates and the plurality of negative plates; and
electrolyte within the container;
wherein the battery has a weight which is less than 20 kilograms and a cold cranking amp performance rating of 720 Amps.

10. The lead acid battery of claim 9, wherein the cells include a greater number of positive plates, negative plates, and absorbent glass mats than a battery of a standard battery group size based upon a volume of the container.

11. The lead acid battery of claim 9, wherein the plurality of positive plates and negative plates comprise grids having a radial grid pattern with an active material thereon.

12. The lead acid battery of claim 9, wherein at least the positive plates or negative plates have an imprinted pattern on a surface.

13. An LN3 lead acid battery comprising:
a container;
one or more electrically connected cells in the container formed by a plurality of positive plates and a plurality of negative plates, wherein an absorbent glass mat is interleaved between positive and negative plates from the plurality of positive plates and the plurality of negative plates; and
electrolyte within the container;
wherein the battery has a weight which is less than 22 kilograms and a cold cranking amp performance rating of 800 Amps.

14. The lead acid battery of claim 13, wherein the cells include a greater number of positive plates, negative plates, and absorbent glass mats than a battery of a standard battery group size based upon a volume of the container.

15. The lead acid battery of claim 13, wherein the plurality of positive plates and negative plates comprise grids having a radial grid pattern with an active material thereon.

16. The lead acid battery of claim 13, wherein at least the positive plates or negative plates have an imprinted pattern on a surface.

17. An LN4 lead acid battery comprising:
a container;
one or more electrically connected cells in the container formed by a plurality of positive plates and a plurality of negative plates, wherein an absorbent glass mat is interleaved between positive and negative plates from the plurality of positive plates and the plurality of negative plates; and
electrolyte within the container;
wherein the battery has a weight which is less than 26 kilograms and a cold cranking amp performance rating of 850 Amps.

18. The lead acid battery of claim 17, wherein the cells include a greater number of positive plates, negative plates, and absorbent glass mats than a battery of a standard battery group size based upon a volume of the container.

19. The lead acid battery of claim 17, wherein the plurality of positive plates and negative plates comprise grids having a radial grid pattern with an active material thereon.

20. The lead acid battery of claim 17, wherein at least the positive plates or negative plates have an imprinted pattern on a surface.
